(19) United States
(12) Patent Application Publication
(10) Pub. No.: US 2026/0289662 A1
(43) Pub. Date: Sep. 24, 2026

(54) ARTIFICIAL INTELLIGENCE-BASED CASE-STYLE RISK CONTROL METHOD, APPARATUS, DEVICE AND MEDIUM

(71) Applicant: Tianmian Information Technology (Shenzhen) Co., Ltd., Shenzhen (CN)

(72) Inventors: Huan Sheng, Shenzhen (CN); Cheng Shao, Shenzhen (CN); Huanming Wu, Shenzhen (CN)

(21) Appl. No.: 19/243,034

(22) Filed: Jun. 19, 2025

(30) Foreign Application Priority Data
Mar. 20, 2025 (CN) 202510333744.3

(51) Int. Cl. G06Q 40/03; G06F 16/93

(52) U.S. Cl. CPC G06Q 40/03; G06F 16/93

(57) ABSTRACT

The present invention discloses an artificial intelligence-based case-style risk control method, apparatus, a device and a medium. The method includes the following steps of: performing data stratification and document conversion on pre-acquired user information set to obtain a user data document set; performing a temporal embedding operation on the user data document set to obtain a user document feature set; performing data standardization and database archiving on pre-acquired historical approval data to obtain an approval case library; performing multi-dimensional similarity matching on the user document set according to the approval case library to obtain a matched decision result set; performing autoregressive approval analysis on the user document feature set to obtain an analyzed decision result set; and generating a risk control decision result set according to the matched decision result set and the analyzed decision result set. The present invention can enhance the flexibility of risk control approval.

### CROSS REFERENCE TO RELATED APPLICATIONS

The present application claims the benefit of Chinese Patent Application No. 202510333744.3 filed on Mar. 20, 2025, the contents of which are incorporated herein by reference in their entirety.

### TECHNICAL FIELD

The present application relates to the field of data analysis and fintech, and more particularly, to an artificial intelligence-based case-style risk control method, apparatus, a device and a medium.

### BACKGROUND

Risk control approval is a process in business operations that involves reviewing, evaluating, and deciding whether to approve relevant applications or actions (such as loan applications, credit card approvals, insurance underwriting, or business collaborations) based on risk assessment models and review rules. The core of risk control approval lies in identifying, assessing, controlling, and mitigating risks to ensure corporate interests and operational security.

Traditional risk control approval methods are rule-based risk control approval methods, which establish a series of fixed rules and make approval decisions according to the degree of compliance between user data and these rules. In practice, due to the non-standardized and frequently changing nature of risk control rules, such rule-based methods exhibit poor flexibility and weak adaptability to complex scenarios.

### SUMMARY

The present application provides an artificial intelligence-based case-style risk control method, apparatus, a device and a medium, so as to solve the technical problem of low flexibility of risk control approval due to different rules of each risk control approval when performing risk control approval of a financial system.

In a first aspect, an artificial intelligence-based case-style risk control method is provided, the method is based on storing and executing a computer program in an electronic device to generate a risk control decision result set applied for case-style risk control, wherein the computer program, when executed by the electronic device, controls the electronic device to perform the following steps of:
performing data stratification and document conversion on pre-acquired user information set to obtain a user data document set;
performing a temporal embedding operation on the user data document set to obtain a user document feature set;
performing data standardization and database archiving on pre-acquired historical approval data to obtain an approval case library;
performing multi-dimensional similarity matching on the user document feature set according to the approval case library to obtain a matched decision result set;
performing autoregressive approval analysis on the user document feature set according to the approval case library to obtain an analyzed decision result set; and
generating a risk control decision result set according to the matched decision result set and the analyzed decision result set.

In a second aspect, an artificial intelligence-based case-style risk control apparatus is provided, which includes:
a document conversion module configured to perform data stratification and document conversion on pre-acquired user information set to obtain a user data document set;
a feature extraction module configured to perform a temporal embedding operation on the user data document set to obtain a user document feature set;
a data archiving module configured to perform data standardization and database archiving on pre-acquired historical approval data to obtain an approval case library;
a matched decision module configured to perform multi-dimensional similarity matching on the user document feature set according to the approval case library to obtain a matched decision result set;
an analysis decision module configured to perform autoregressive approval analysis on the user document feature set according to the approval case library to obtain an analyzed decision result set; and
a risk control decision module configured to generate a risk control decision result set according to the matched decision result set and the analyzed decision result set.

In a third aspect, an electronic device is provided, which includes a memory, a processor, and a computer program stored in the memory and executable on the processor, where the computer program when executed by the processor implements the artificial intelligence-based case-style risk control method described above.

In a fourth aspect, a computer-readable storage medium is provided, which stores a computer program which, when executed by a processor, implements the artificial intelligence-based case-style risk control method described above.

In the solution implemented by the above-mentioned artificial intelligence-based case-style risk control method, apparatus, electronic device and storage medium, a user data document set can be obtained by performing data stratification and document conversion on a pre-acquired user information set, so as to complete primary data classification and arrangement, and archiving according to the importance of data, so as to realize formatted data storage, facilitate subsequent analysis on data, and improve the efficiency of risk control approval; and a user document feature set is obtained by performing a temporal embedding operation on the user data document set, which can convert the user data document set into a feature form convenient for calculation, reduce the calculation dimension, improve the efficiency of risk control approval, and also facilitate the subsequent feature matching; the approval case library can be obtained by data standardization and database archiving on the pre-acquired historical approval data, which can realize the archiving and storage of historical data, and facilitate the subsequent quick similarity retrieval and similarity calculation, and improve the flexibility of risk control approval.

By performing multi-dimensional similarity matching on the user document feature set according to the approval case library to obtain a matched decision result set, it is possible to perform similarity matching by combining features from three dimensions: core data, behavior features, and derived data, thereby improving the accuracy of approval result matching, and enabling flexible approval result matching based on historical record data, thus enhancing the flexibility of risk control approval; by performing autoregressive approval analysis on the user document feature set according to the approval case library to obtain an analyzed decision result set, it is possible to achieve risk control approval for the user document feature set using deep learning methods, thereby improving the flexibility of risk control approval, and by generating a risk control decision result set based on the matched decision result set and the analyzed decision result set, it is possible to perform risk control approval based on feature matching and autoregressive models, expanding the scope of risk control approval, reducing human resource consumption, and increasing the flexibility of risk control approval.

### BRIEF DESCRIPTION OF THE ACCOMPANYING DRAWINGS

In order to explain the embodiments of the present application or the technical solutions in the prior art more clearly, a brief description will be given below of the drawings which need to be used in the embodiments. It is obvious that the drawings in the following description are only some embodiments of the present application, and it would have been obvious for a person skilled in the art to obtain other drawings according to these drawings without involving any inventive effort.

FIG. 1 is a schematic diagram showing an application environment of an artificial intelligence-based case-style risk control method according to an embodiment of the present application;

FIG. 2 is a schematic flow diagram showing an artificial intelligence-based case-style risk control method according to an embodiment of the present application;

FIG. 3 is a schematic flow diagram showing a specific embodiment of step S20 of FIG. 2;

FIG. 4 is a schematic flow diagram showing a specific embodiment of step S30 of FIG. 2;

FIG. 5 is a schematic flow diagram showing a specific embodiment of step S40 of FIG. 2;

FIG. 6 is a schematic structural diagram showing an artificial intelligence-based case-style risk control apparatus according to an embodiment of the present application;

FIG. 7 is a schematic structural diagram showing an electronic device according to an embodiment of the present application; and

FIG. 8 is another schematic structural diagram showing an electronic device according to an embodiment of the present application.

### DETAILED DESCRIPTION OF ILLUSTRATED EMBODIMENTS

The technical solutions in the embodiments of the present application will be clearly and completely described below in conjunction with the accompanying drawings in the embodiments of the present application. It is apparent that the described embodiments are only part of the embodiments of the present application, rather than all the embodiments. Based on the embodiments of the present application, all other embodiments obtained by a person skilled in the art without inventive effort fall within the scope of the present application.

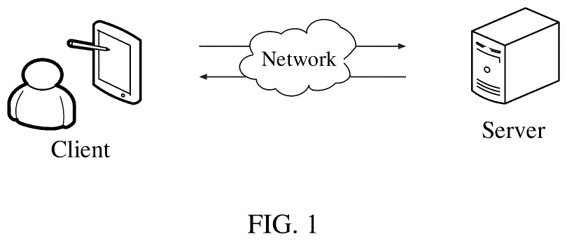

An artificial intelligence-based case-style risk control method provided by an embodiment of the present application can be applied in an application environment as shown in FIG. 1, where a client communicates with a server via network. A user data document set can be obtained by performing data stratification and document conversion on a pre-acquired user information set via a client; a temporal embedding operation is performed on the user data document set to obtain a user document feature set; the pre-acquired historical approval data are performed data standardization and database archiving to obtain an approval case library; the user document feature set is performed multi-dimensional similarity matching according to the approval case library to obtain a matched decision result set; the user document feature set is performed autoregressive approval analysis according to the approval case library to obtain an analyzed decision result set; a risk control decision result set is generated according to the matched decision result set and the analyzed decision result set, and in the present application, the multi-dimensional similarity matching on the user document feature set according to the approval case library to obtain a matched decision result set includes: user document features are selected from the user document feature set one by one as target user document features, and historical document features are selected from the historical document feature set in the approval case library one by one as target historical document features; the target user document feature and the target historical document feature are performed multi-dimensional similarity calculation to obtain multi-dimensional matching degrees; the multi-dimensional matching degrees of all the target historical document features in the approval case library are aggregated into a multi-dimensional matching degree set; the multi-dimensional matching degree set is performed extremum filtering to obtain an extremum matching degree, and target historical document features corresponding to the extremum matching degrees are taken as a matched historical document features; a user approval result corresponding to the matched historical document feature in the approval case library is taken as a matched decision result; the matched decision results corresponding to all the target user document features in the user document feature set are aggregated into a matched decision result set, and it is possible to perform similarity matching by combining features from three dimensions: core data, behavior features, and derived data, thereby improving the accuracy of approval result matching, and enabling flexible approval result matching based on historical record data, thus enhancing the flexibility of risk control approval. The client may be, but is not limited to, a variety of personal computers, notebook computers, smart phones, tablet computers, and portable wearable devices. The server may be implemented as a stand-alone server or as a server cluster of multiple servers. The present application will now be described in more detail by way of specific examples.

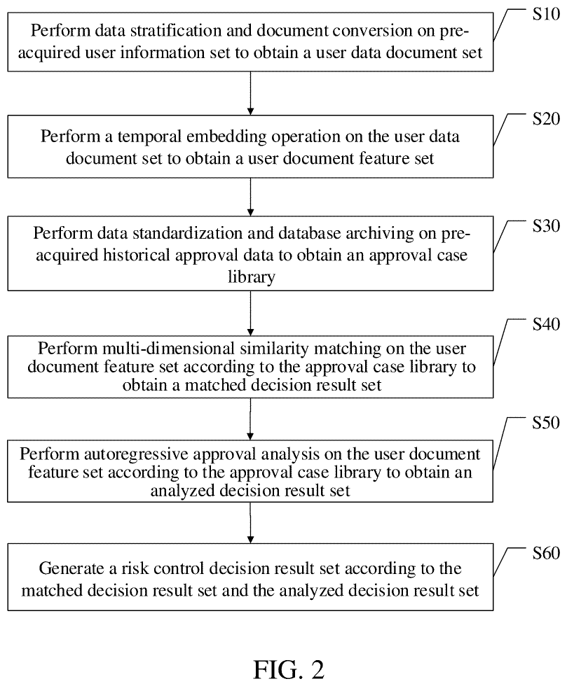

Referring to FIG. 2, FIG. 2 is a schematic flow diagram showing an artificial intelligence-based case-style risk control method according to an embodiment of the present application, the method including the following steps of:

S10 Perform data stratification and document conversion on pre-acquired user information set to obtain a user data document set.

In detail, the user information set refers to a set composed of collected user-related information, and each user information in the user information set includes personal information about the user, historical transaction records and credit data, where the personal information includes personal income information, the historical transaction records includes repayment records, and the credit data includes information such as loan application history.

Specifically, each user data document in the user data document set is user information in the user information set in a hierarchically stored document format, and the user data document includes three data layers of a core data layer, a behavior feature layer, and a derivative data layer.

In detail, the core data layer includes high credibility data, such as an income certificate and an asset certificate; key credit data, such as credit records and repayment history, and stability index data, such as professional information and working years, where the data in the core data layer directly influences risk control decision-making, and strict structured storage and independent index are required.

Specifically, the behavior feature layer includes dynamic data, such as consumption behavior and transaction frequency; behavior track data such as device usage habits and location information and social attribute data such as a social network and an interest preference, and the data in the behavior feature layer is converted into a label or an indicator through feature engineering and then stored.

In detail, the derivative data layer includes various types of risk indicator data calculated according to the core data; and user portrait label data based on the behavior data summary and decision support information data related to historical approval, where the data in the derivative data layer is configured to perform secondary processing data assisting in decision-making.

In the embodiments of the present application, the pre-acquired user information set is performed data stratification and document conversion to obtain a user data document set includes:
the pre-acquired user information set is performed data cleaning to obtain a cleaning information set;
cleaning information is selected from the cleaning information set one by one as target cleaning information, and the target cleaning information is performed core data matching to obtain target core data;
the target cleaning information is performed behavior feature extraction to obtain target behavior features;
the target cleaning information is performed risk indicator extraction to obtain target derivative data;
the target core data, the target behavior features and the target derivative data are performed document conversion to obtain a user data document; and
a user data document set is generated from the user data documents for all target cleaning information in the cleaning information set.

In detail, the data cleaning includes removing duplicate or invalid data entries; supplementing missing values using mean filling or pattern filling, unifying the data unit and format, and ensuring the consistency of data field.

Specifically, the core data matching refers to matching high credibility data, such as income certificate and asset certificate, by means of keyword matching; key credit data such as credit records and repayment history, and stability indicator data such as professional information and working years are taken as the target core data.

In detail, the behavior feature extraction refers to extracting dynamic data such as consumption behavior and transaction frequency through regular expression combined with feature engineering and other methods; behavior track data such as device usage habits and location information, and social attribute data such as social network and interest preference, as target behavior features.

Specifically, the risk indicator extraction refers to extracting various types of risk indicator data calculated according to the core data by means of keyword matching; user portrait label data based on behavior data summary and decision support information data related to historical approval as target derivative data.

In detail, the document conversion refers to converting the target core data, the target behavior features and the target derivative data into a document format having a hierarchical structure, for example, a user data document converted into a document format such as JSON, CSV, or data report using a tool such as Python Pandas.

In the embodiments of the present application, by performing data stratification and document conversion on the pre-acquired user information set, a user data document set is obtained, which can complete preliminary data classification and arrangement, and is archived according to the importance of the data, thus realizing formatted data storage, facilitating subsequent data analysis, and improving the efficiency of risk control approval.

S20 Perform a temporal embedding operation on the user data document set to obtain a user document feature set.

In detail, each user document feature in the user document feature set is a characterization vector of a corresponding user data document in the user data document set, which is configured to reflect user data information.

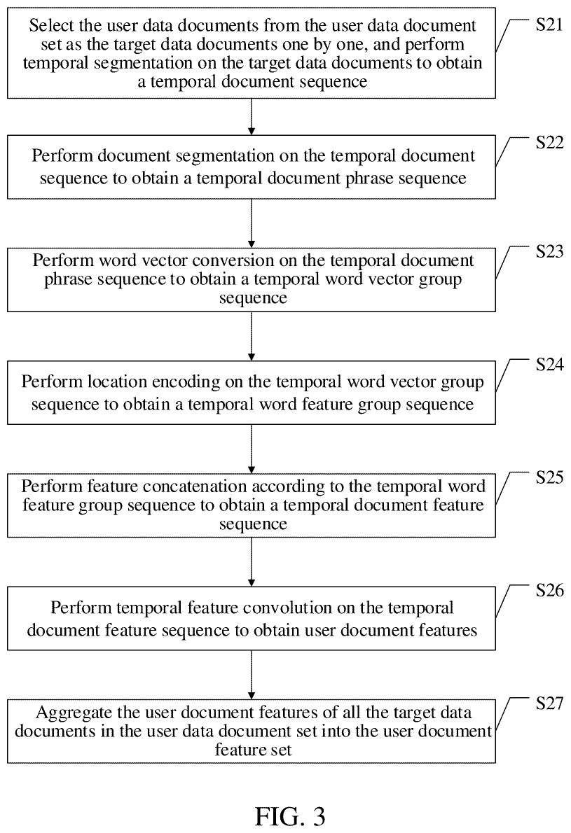

In the embodiments of the present application, as shown referring to FIG. 3, the performing a temporal embedding operation on the user data document set to obtain a user document feature set includes:
S21 Select the user data documents from the user data document set as the target data documents one by one, and perform temporal segmentation on the target data documents to obtain a temporal document sequence;
S22 Perform document segmentation on the temporal document sequence to obtain a temporal document phrase sequence;
S23 Perform word vector conversion on the temporal document phrase sequence to obtain a temporal word vector group sequence;
S24 Perform location encoding on the temporal word vector group sequence to obtain a temporal word feature group sequence;
S25 Perform feature concatenation according to the temporal word feature group sequence to obtain a temporal document feature sequence;
S26 Perform temporal feature convolution on the temporal document feature sequence to obtain user document features;
S27 Aggregate the user document features of all the target data documents in the user data document set into the user document feature set.

In detail, the document segmentation means that document segmentation is a process of decomposing a piece of text into several smaller units, and the word vector conversion is a process of transforming a word or a sub-word obtained from the segmentation into a vector representation of a fixed dimension through mapping, capturing semantic or syntactic information, and being configured to allow a machine to understand and operate on a numerical representation of the text; the document segmentation can be performed by using a bidirectional maximum matching method, and word vector conversion can be performed by using encoding methods such as One Hot Encoding, Word2Vec, GloVe and BERT.

Specifically, the location encoding is configured to provide location information for each word in the sequence so as to compensate for the defect that a model such as Transformer has insufficient sensitivity to the location information, and the location encoding can be performed by using a method such as ALiBi or dynamic location encoding.

Specifically, the feature concatenation is a process of combining features from different sources or different dimensions to form a uniform vector representation, and can be performed by using methods such as attention weighted concatenation, weighted average concatenation or linear concatenation.

In detail, the temporal feature convolution is a process of performing a convolution operation on data having a time dimension in order to capture local features and variation patterns in the temporal data, and the temporal feature convolution can be performed using pyramid convolution, dynamic convolution or dilated convolution.

In the embodiments of the present application, by performing a temporal embedding operation on the user data document set, a user document feature set is obtained, and the user data document set can be converted into a feature form which is convenient for calculation, so as to reduce the calculation dimension, improve the efficiency of risk control approval, and also facilitate subsequent feature matching.

S30 Perform data standardization and database archiving on pre-acquired historical approval data to obtain an approval case library.

In detail, the historical approval data refers to user information processed by means of manual approval and the like in the past time period and corresponding approval results, where the approval results include approval success, approval failure and the like.

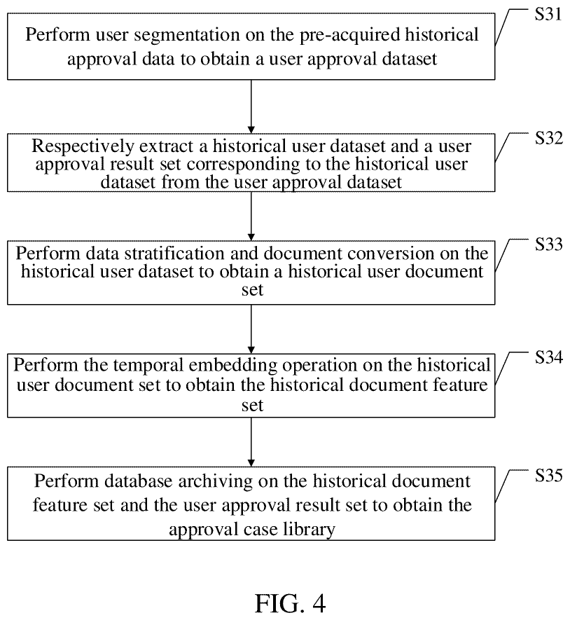

In the embodiments of the present application, as shown in FIG. 4, the performing data standardization and database archiving on pre-acquired historical approval data to obtain an approval case library includes:

S31 Perform user segmentation on the pre-acquired historical approval data to obtain a user approval dataset;

S32 Respectively extract a historical user dataset and a user approval result set corresponding to the historical user dataset from the user approval dataset;

S33 Perform data stratification and document conversion on the historical user dataset to obtain a historical user document set;

S34 Perform the temporal embedding operation on the historical user document set to obtain the historical document feature set; and

S35 Perform database archiving on the historical document feature set and the user approval result set to obtain the approval case library.

In detail, the user segmentation refers to segmenting the historical approval data into approval data corresponding to each user according to a unique identifier of the user, and each user approval data in the user approval dataset refers to user information corresponding to a user and a corresponding approval result which have been processed by means of manual approval in the past time period, etc.

Specifically, each of the historical user data in the historical user dataset corresponds to a user data in each of the user approval data in the user approval dataset, and each of the user approval results in the user approval result set corresponds to an approval result of each of the user approval data in the user approval dataset.

In detail, the method of the data stratification and document conversion is identical to the method of the above-mentioned step S10, and the method of the temporal embedding operation is identical to the method of the above-mentioned step S20, which will not be described in detail herein.

Specifically, the database archiving means that each historical document feature in the historical document feature set and a corresponding user approval result in the user approval result set are correspondingly stored in the database.

In the embodiments of the present application, by performing data standardization and database archiving on pre-acquired historical approval data, an approval case library is obtained, which can realize the archiving and storage of historical data, facilitate the subsequent rapid similarity retrieval and similarity calculation, and improve the flexibility of risk control approval.

S40 Perform multi-dimensional similarity matching on the user document feature set according to the approval case library to obtain a matched decision result set.

In detail, each matched decision result in the matched decision result set corresponds to a matching result of a risk control approval of a user of each user document feature in the user document feature set.

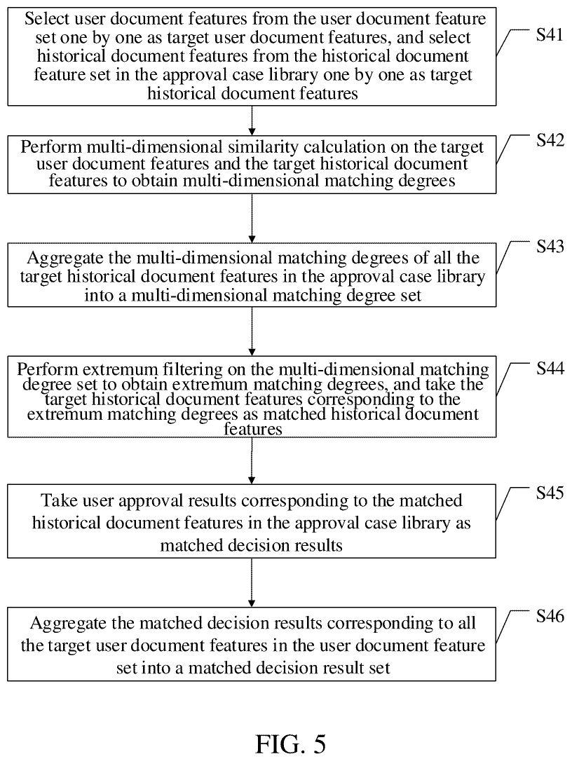

In the embodiments of the present application, as shown referring to FIG. 5, the performing multi-dimensional similarity matching on the user document feature set according to the approval case library to obtain a matched decision result set includes:
S41 Select user document features from the user document feature set one by one as target user document features, and select historical document features from the historical document feature set in the approval case library one by one as target historical document features;
S42 Perform multi-dimensional similarity calculation on the target user document features and the target historical document features to obtain multi-dimensional matching degrees;
S43 Aggregate the multi-dimensional matching degrees of all the target historical document features in the approval case library into a multi-dimensional matching degree set;
S44 Perform extremum filtering on the multi-dimensional matching degree set to obtain extremum matching degrees, and take the target historical document features corresponding to the extremum matching degrees as matched historical document features;
S45 Take user approval results corresponding to the matched historical document features in the approval case library as matched decision results; and
S46 Aggregate the matched decision results corresponding to all the target user document features in the user document feature set into a matched decision result set.

Specifically, the extremum filtering refers to taking the multi-dimensional matching degree with the maximum value of the multi-dimensional matching degree in the multi-dimensional matching degree set as the extremum matching degree.

In detail, the performing multi-dimensional similarity calculation on the target user document features and the target historical document features to obtain multi-dimensional matching degrees includes:
the target user document features are performed feature hierarchy segmentation to obtain user core features, user behavior features and user derived features;
a matched weight group is calculated according to the user core features, the user behavior features and the user derived features;
the target historical document features are performed feature hierarchy segmentation to obtain historical core features, historical behavior features and historical derived features;
core feature matching degrees are calculated according to the user core features and the historical core features;
behavior feature matching degrees are calculated according to the user behavior features and the historical behavior features;
derivative feature matching degrees are calculated according to the user derived features and the historical derived features; and
the core feature matching degrees, the behavior feature matching degrees and the derivative feature matching degrees are performed weighted summation according to the matched weight group to obtain multi-dimensional matching degrees.

Specifically, the feature hierarchy segmentation refers to segmentation features in the target user document features according to the hierarchical structure of the data stratification; the user core features correspond to partial features corresponding to a core data layer in the target user document features; the user behavior features correspond to partial features corresponding to a behavior feature layer in the target user document features; and the user derived features correspond to partial features corresponding to a derivative data layer in the target user document features.

In detail, the matched weight group can be calculated using the following formula:

$$w = soft max ( MLP ( Transformer ( [ {S}_{core} , {S}_{behavior} , {S}_{derived} , {S}_{risk - context} ] ) ) )$$

where w is the matched weight group, softmax is a normalization function, MLP is a multi-layer perceptron network, Transformer refers to an Transformer attention neural network, S_{core} refers to the user core feature, S_{behavior} refers to the user behavior feature, S_{derived} refers to the user derived feature, S_{risk-context} refers to a pre-set risk control feature, [S_{core}, S_{behavior}, S_{derived}, S_{risk-context}] refers to performing a vector splicing operation on the user core feature, the user behavior feature, the user derived feature and the risk control feature.

In detail, the historical core features correspond to partial features corresponding to a core data layer in the target historical document features; the historical behavior features correspond to partial features corresponding to a behavior feature layer in the target historical document features; and the historical derived features correspond to partial features corresponding to a derivative data layer in the target historical document features.

Specifically, a cosine similarity distance algorithm can be configured to calculate core feature matching degrees according to the user core features and the historical core features; a Dynamic Time Warping (DTW) can be configured to calculate behavior feature matching degrees according to the user behavior features and the historical behavior features; and a Jaccard Similarity algorithm can be configured to calculate derivative feature matching degrees according to the user derived features and the historical derived features.

In detail, the cosine similarity algorithm is an algorithm for measuring the similarity of cosine values of an included angle between two vectors, the dynamic time warping is configured to calculate the similarity among time sequences, i.e., two time sequences can find their optimal matching paths even if there is an offset in the time dimension, so that the overall similarity is optimal, and the Jaccard similarity algorithm is configured to measure the similarity of two sets.

Specifically, when the core feature matching degrees, the behavior feature matching degrees and the derivative feature matching degrees are performed weighted summation according to the matched weight group, it means that a matching core weight of the user core feature, a matching behavior weight of the user behavior feature and a derived matching weight of the user derived feature are respectively extracted from the matched weight group, the matching core weight is multiplied by the user core feature, the result is multiplied by a parameter weight value of the user core feature, and the matching behavior weight is multiplied by the user behavior feature; and the result is multiplied by a parameter weight value of the user behavior feature, the matching derived weight is multiplied by the user derived feature, and the result is multiplied by a parameter weight value of the user derived feature.

In detail, the parameter weight value of the core feature matching degree is greater than the parameter weight value of the behavior feature matching degree, the parameter weight value of the behavior feature matching degree is greater than the parameter weight value of the derivative feature matching degree, and by default, the parameter weight value of the core feature matching degree is 0.6, the parameter weight value of the behavior feature matching degree is 0.3, and the parameter weight value of the derivative feature matching degree is 0.1.

In the embodiments of the present application, by performing multi-dimensional similarity matching on the user document feature set according to the approval case library to obtain a matched decision result set, it is possible to perform similarity matching by combining features from three dimensions: core data, behavior features, and derived data, thereby improving the accuracy of approval result matching, and enabling flexible approval result matching based on historical record data, thus enhancing the flexibility of risk control approval.

S50 Perform autoregressive approval analysis on the user document feature set according to the approval case library to obtain an analyzed decision result set.

In detail, each analyzed decision result in the analyzed decision result set corresponds to a decision result obtained by the approval analysis of a corresponding user document feature in the user document feature set according to a deep learning model.

In the embodiments of the present application, the performing autoregressive approval analysis on the user document feature set according to the approval case library to obtain an analyzed decision result set includes:
the historical document feature set in the approval case library is performed approval analysis using a pre-set autoregressive model to obtain the analyzed approval result set;
a result loss value between the user approval result set in the approval case library and the analyzed approval result set is calculated;
the autoregressive model is performed iterative model training according to the result loss value to obtain an approval case model; and
the user document feature set is performed approval analysis using the approval case model to obtain an analyzed decision result set.

Specifically, the autoregressive model may be a long short-term memory neural network model, an autoregressive neural network model such as Transformer, GPT, or the like.

In detail, the result loss value can be calculated by a loss value algorithm in combination with the temporal variance of each user approval result in the user approval result set, where the loss value algorithm can be a mean square error loss value algorithm, a mean absolute error algorithm, a Huber loss value algorithm or a log cosine loss value algorithm.

In detail, a gradient descent algorithm, an adaptive learning rate algorithm or a particle swarm algorithm, and a differential evolution algorithm can be configured to perform iterative model training, i.e., the gradient descent algorithm, the adaptive learning rate algorithm or the particle swarm algorithm, and the differential evolution algorithm are configured to adjust the model parameters of the autoregressive model according to the result loss value, and the process returns to the step of using a pre-set autoregressive model to perform approval analysis on the historical document feature set in the approval case library so as to obtain an analyzed approval result set; until the result loss value is less than a pre-set loss threshold or the number of iterations is greater than a pre-set iteration threshold, and an approval case model is obtained.

In the embodiments of the present application, by performing autoregressive approval analysis on the user document feature set according to the approval case library to obtain an analyzed decision result set, risk control approval on the user document feature set can be realized by using a deep learning method, thereby improving the flexibility of risk control approval.

S60 Generate a risk control decision result set according to the matched decision result set and the analyzed decision result set.

In the embodiments of the present application, each risk control decision result in the risk control decision result set corresponds to an approval result of risk control approval of each user information in the user information set.

In detail, the generating a risk control decision result set according to the matched decision result set and the analyzed decision result set refers to performing a weighted summation of confidence degrees or matching degrees according to each matched decision result in the matched decision result set and a corresponding analyzed decision result in the analyzed decision result set so as to obtain a final decision result. For example, if the matched decision result is an approval failure, the weight is 0.4, and the matching degree is 60%, and the analyzed decision result is an approval success, the weight is 0.6, and the confidence degree is 90%, then the risk control decision result is an approval success, where when the weighted summation result is zero, the risk control decision result can be submitted to a human for approval.

In the embodiments of the present application, by generating a risk control decision result set according to the matched decision result set and the analyzed decision result set, risk control approval can be performed according to feature matching and autoregressive models, the scope of approval of the risk control approval is expanded, human resource consumption is reduced, and the flexibility of the risk control approval is improved.

It can be seen that in the above-mentioned solution, a user data document set can be obtained by performing data stratification and document conversion on a pre-acquired user information set, so as to complete primary data classification and arrangement, and archiving according to the importance of data, so as to realize formatted data storage, facilitate subsequent analysis on data, and improve the efficiency of risk control approval; and a user document feature set is obtained by performing a temporal embedding operation on the user data document set, which can convert the user data document set into a feature form convenient for calculation, reduce the calculation dimension, improve the efficiency of risk control approval, and also facilitate the subsequent feature matching; the approval case library can be obtained by data standardization and database archiving on the pre-acquired historical approval data, which can realize the archiving and storage of historical data, and facilitate the subsequent quick similarity retrieval and similarity calculation, and improve the flexibility of risk control approval.

By performing multi-dimensional similarity matching on the user document feature set according to the approval case library to obtain a matched decision result set, it is possible to perform similarity matching by combining features from three dimensions: core data, behavior features, and derived data, thereby improving the accuracy of approval result matching, and enabling flexible approval result matching based on historical record data, thus enhancing the flexibility of risk control approval; by performing autoregressive approval analysis on the user document feature set according to the approval case library to obtain an analyzed decision result set, it is possible to achieve risk control approval for the user document feature set using deep learning methods, thereby improving the flexibility of risk control approval, and by generating a risk control decision result set based on the matched decision result set and the analyzed decision result set, it is possible to perform risk control approval based on feature matching and autoregressive models, expanding the scope of risk control approval, reducing human resource consumption, and increasing the flexibility of risk control approval.

It should be understood that the size of the sequence numbers of the steps in the above embodiments is not meant to imply a sequence of carrying out these steps which should be determined by their function and inherent logic, and should not be construed as limiting the implementation of the embodiments of the present application in any way.

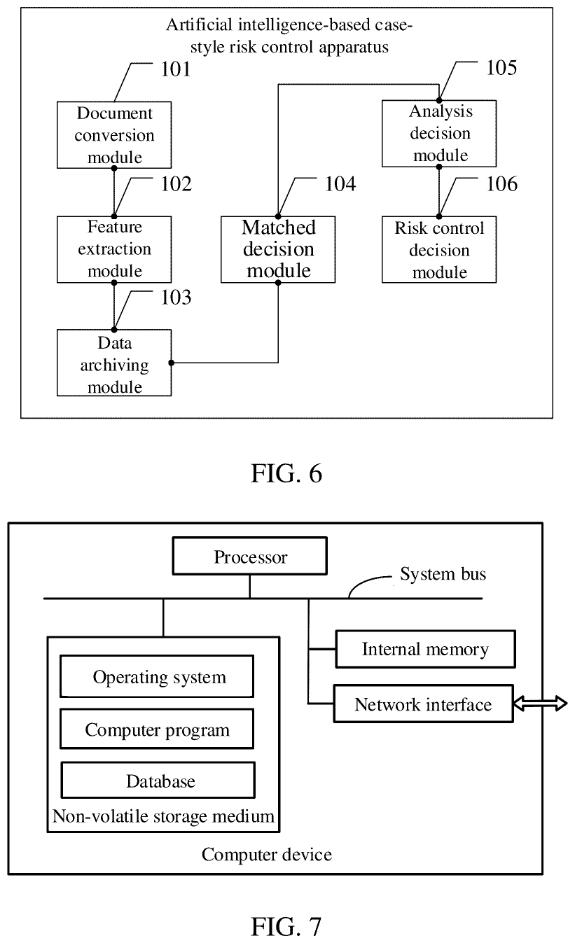

In one embodiment, an artificial intelligence-based case-style risk control apparatus is provided, which corresponds one by one with the artificial intelligence-based case-style risk control method of the above-described embodiment. As shown in FIG. 6, the artificial intelligence-based case-style risk control apparatus includes a document conversion module 101, a feature extraction module 102, a data archiving module 103, a matched decision module 104, an analysis decision module 105 and a risk control decision module 106. Each functional module is described in detail as follows:
the document conversion module 101 is configured to perform data stratification and document conversion on pre-acquired user information set to obtain a user data document set;
the feature extraction module 102 is configured to perform a temporal embedding operation on the user data document set to obtain a user document feature set;
the data archiving module 103 is configured to perform data standardization and database archiving on pre-acquired historical approval data to obtain an approval case library;
the matched decision module 104 is configured to perform multi-dimensional similarity matching on the user document feature set according to the approval case library to obtain a matched decision result set;
the analysis decision module 105 is configured to perform autoregressive approval analysis on the user document feature set according to the approval case library to obtain an analyzed decision result set; and
the risk control decision module 106 is configured to generate a risk control decision result set according to the matched decision result set and the analyzed decision result set.

In one embodiment, the document conversion module 101, when performing data stratification and document conversion on a pre-acquired user information set to obtain a user data document set, is configured to:
perform data cleaning on the pre-acquired user information set to obtain a cleaning information set;
select cleaning information from the cleaning information set one by one as target cleaning information, and perform core data matching on the target cleaning information to obtain target core data;
perform behavior feature extraction on the target cleaning information to obtain target behavior features;
perform risk indicator extraction on the target cleaning information to obtain target derivative data;
perform document conversion on the target core data, the target behavior features and the target derivative data to obtain a user data document; and
generate the user data document set from the user data documents for all target cleaning information in the cleaning information set.

In one embodiment, the feature extraction module 102, when performing a temporal embedding operation on the user data document set to obtain a user document feature set, is configured to:
select the user data documents from the user data document set as the target data documents one by one, and perform temporal segmentation on the target data documents to obtain a temporal document sequence;
perform document segmentation on the temporal document sequence to obtain a temporal document phrase sequence;
perform word vector conversion on the temporal document phrase sequence to obtain a temporal word vector group sequence;
perform location encoding on the temporal word vector group sequence to obtain a temporal word feature group sequence;
perform feature concatenation according to the temporal word feature group sequence to obtain a temporal document feature sequence;
perform temporal feature convolution on the temporal document feature sequence to obtain user document features; and
aggregate the user document features of all the target data documents in the user data document set into the user document feature set.

In one embodiment, the data archiving module 103, when performing data standardization and database archiving on the pre-acquired historical approval data to obtain an approval case library, is configured to:
perform user segmentation on the pre-acquired historical approval data to obtain a user approval dataset;
respectively extract a historical user dataset and a user approval result set corresponding to the historical user dataset from the user approval dataset;
perform data stratification and document conversion on the historical user dataset to obtain a historical user document set;
perform the temporal embedding operation on the historical user document set to obtain the historical document feature set; and
perform database archiving on the historical document feature set and the user approval result set to obtain the approval case library.

In one embodiment, the matched decision module 104, when performing multi-dimensional similarity matching on the user document feature set according to the approval case library to obtain a matched decision result set, is configured to:
select user document features from the user document feature set one by one as target user document features, and select historical document features from the historical document feature set in the approval case library one by one as target historical document features;
perform multi-dimensional similarity calculation on the target user document features and the target historical document features to obtain multi-dimensional matching degrees;
aggregate the multi-dimensional matching degrees of all the target historical document features in the approval case library into a multi-dimensional matching degree set;
perform extremum filtering on the multi-dimensional matching degree set to obtain extremum matching degrees, and take the target historical document features corresponding to the extremum matching degrees as matched historical document features;
take user approval results corresponding to the matched historical document features in the approval case library as matched decision results; and
aggregate the matched decision results corresponding to all the target user document features in the user document feature set into a matched decision result set.

In one embodiment, the matched decision module 104, when performing multi-dimensional similarity calculation on the target user document features and the target historical document features to obtain multi-dimensional matching degrees, is configured to:
perform feature hierarchy segmentation on the target user document features to obtain user core features, user behavior features and user derived features;
calculate a matched weight group according to the user core features, the user behavior features and the user derived features;
perform feature hierarchy segmentation on the target historical document features to obtain historical core features, historical behavior features and historical derived features;
calculate core feature matching degrees according to the user core features and the historical core features;
calculate behavior feature matching degrees according to the user behavior features and the historical behavior features;
calculate derivative feature matching degrees according to the user derived features and the historical derived features; and
perform weighted summation on the core feature matching degrees, the behavior feature matching degrees and the derivative feature matching degrees according to the matched weight group to obtain multi-dimensional matching degrees.

In one embodiment, the analysis decision module 105, when performing autoregressive approval analysis on the user document feature set according to the approval case library to obtain an analyzed decision result set, is configured to:
perform approval analysis on the historical document feature set in the approval case library using a pre-set autoregressive model to obtain the analyzed approval result set;
calculate a result loss value between the user approval result set in the approval case library and the analyzed approval result set;
perform iterative model training on the autoregressive model according to the result loss value to obtain an approval case model; and
perform approval analysis on the user document feature set using the approval case model to obtain an analyzed decision result set.

The present application provides an artificial intelligence-based case-style risk control apparatus, a user data document set can be obtained by performing data stratification and document conversion on a pre-acquired user information set, so as to complete primary data classification and arrangement, and archiving according to the importance of data, so as to realize formatted data storage, facilitate subsequent analysis on data, and improve the efficiency of risk control approval; and a user document feature set is obtained by performing a temporal embedding operation on the user data document set, which can convert the user data document set into a feature form convenient for calculation, reduce the calculation dimension, improve the efficiency of risk control approval, and also facilitate the subsequent feature matching; the approval case library can be obtained by data standardization and database archiving on the pre-acquired historical approval data, which can realize the archiving and storage of historical data, and facilitate the subsequent quick similarity retrieval and similarity calculation, and improve the flexibility of risk control approval.

By performing multi-dimensional similarity matching on the user document feature set according to the approval case library to obtain a matched decision result set, it is possible to perform similarity matching by combining features from three dimensions: core data, behavior features, and derived data, thereby improving the accuracy of approval result matching, and enabling flexible approval result matching based on historical record data, thus enhancing the flexibility of risk control approval; by performing autoregressive approval analysis on the user document feature set according to the approval case library to obtain an analyzed decision result set, it is possible to achieve risk control approval for the user document feature set using deep learning methods, thereby improving the flexibility of risk control approval, and by generating a risk control decision result set based on the matched decision result set and the analyzed decision result set, it is possible to perform risk control approval based on feature matching and autoregressive models, expanding the scope of risk control approval, reducing human resource consumption, and increasing the flexibility of risk control approval.

Specific definitions of the artificial intelligence-based case-style risk control apparatus can be found in the above definitions of the intelligent question-and-answer method, which will not be described in detail herein. The various modules of the artificial intelligence-based case-style risk control apparatus described above may be implemented in whole or in part by software, hardware, or a combination thereof. The modules may be embedded in hardware or separate from the processor in the electronic device, or may be stored in software in a memory in the electronic device, such that the processor invokes operations corresponding to the modules.

In one embodiment, an electronic device is provided, which may be a server, and an internal block diagram thereof may be as shown in FIG. 7. The electronic device includes a processor, a memory, a network interface, and a database connected by a system bus. The processor of the electronic device is configured to provide computing and control capabilities. The memory of the electronic device includes a non-volatile storage medium and an internal memory. The non-volatile storage medium stores an operating system, computer programs, and a database. The internal memory provides an environment for the operation of the operating system and computer programs in the non-volatile storage medium. The network interface of the electronic device is configured to communicate with an external client via a network connection. The computer program, when executed by the processor, implements the functions or steps of the server of an artificial intelligence-based case-style risk control method.

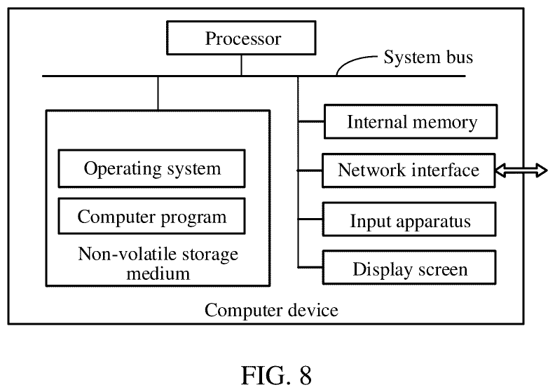

In one embodiment, an electronic device is provided, which may be a client, and an internal block diagram thereof may be as shown in FIG. 8. The electronic device includes a processor, a memory, a network interface, a display screen, and an input apparatus connected by a system bus. The processor of the electronic device is configured to provide computing and control capabilities. The memory of the electronic device includes a non-volatile storage medium, and an internal memory. The non-volatile storage medium stores an operating system and a computer program. The internal memory provides an environment for the operation of the operating system and computer programs in the non-volatile storage medium. The network interface of the electronic device is adapted to communicate with an external server via a network connection. The computer program, when executed by the processor, implements the client functions or steps of an artificial intelligence-based case-style risk control method.

In one embodiment, an electronic device is provided, which includes a memory, a processor and a computer program stored on the memory and executable on the processor, where the processor, when executing the computer program, performs the following steps of:
pre-acquired user information set is performed data stratification and document conversion to obtain a user data document set;
the user data document set is performed temporal embedding operation to obtain a user document feature set;
pre-acquired historical approval data is performed data standardization and database archiving to obtain an approval case library;
the user document feature set is performed multi-dimensional similarity matching according to the approval case library to obtain a matched decision result set;
the user document feature set is performed autoregressive approval analysis according to the approval case library to obtain an analyzed decision result set; and
a risk control decision result set is generated according to the matched decision result set and the analyzed decision result set.

In one embodiment, a computer-readable storage medium is provided, on which a computer program is stored, which when executed by a processor implements the following steps of:
pre-acquired user information set is performed data stratification and document conversion to obtain a user data document set;
the user data document set is performed temporal embedding operation to obtain a user document feature set;
pre-acquired historical approval data is performed data standardization and database archiving to obtain an approval case library;
the user document feature set is performed multi-dimensional similarity matching according to the approval case library to obtain a matched decision result set;
the user document feature set is performed autoregressive approval analysis according to the approval case library to obtain an analyzed decision result set; and
a risk control decision result set is generated according to the matched decision result set and the analyzed decision result set.

It should be noted that the functions or steps described above with respect to the computer-readable storage medium or the electronic device can be implemented by referring to the relevant description of the server and the client in the foregoing method embodiments, will not be described in detail herein in order to avoid repetition.

It will be understood by a person skilled in the art that all or part of the flows of the methods of the embodiments described above may be implemented by hardware instructions of a computer program, which may be stored in a non-volatile computer-readable storage medium, and when executed, may include the flows of the embodiments of the methods described above. Any reference to memory, storage, databases, or other media used in the various embodiments provided herein may include, among other things, nonvolatile and/or volatile memory. Non-volatile memory may include read only memory (ROM), programmable ROM (PROM), electrically programmable ROM (EPROM), electrically erasable programmable ROM (EEPROM), or flash memory. Volatile memory may include random access memory (RAM) or external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink, DRAM (SLDRAM), Rambus direct RAM (RDRAM), direct rambus dynamic RAM (DRDRAM), and a memory bus dynamic RAM (RDRAM) or the like.

It will be clear to a person skilled in the art that, for convenience and conciseness of description, only the above-mentioned division of functional units and modules is exemplified, and in practical applications, the above-mentioned allocation of functions can be performed by different functional units and modules, i.e. dividing the internal structure of the apparatus into different functional units or modules, as required, to perform all or part of the functions described above.

The above-described embodiments are only configured to illustrate the technical solutions of the present application and not to limit it. Although the present application has been described in detail referring to the foregoing embodiments, a person skilled in the art should understand that they can still modify the technical solutions described in the foregoing embodiments or equivalently replace some of the technical features. Such modifications or replacements shall not cause the essence of the corresponding technical solutions to depart from the spirit and scope of the technical solutions of the embodiments of the present application, and shall all be included within the protection scope of the present application. It should be noted that if any non-company software tools or components appear in the embodiments of the present application, they are only configured for illustrative purposes and do not represent actual usage.

What is claimed is:

1. An artificial intelligence-based case-style risk control method, the method being based on storing and executing a computer program in an electronic device to generate a risk control decision result set applied for case-style risk control, wherein the computer program, when executed by the electronic device, controls the electronic device to perform the following steps of:
performing data stratification and document conversion on pre-acquired user information set to obtain a user data document set;
performing a temporal embedding operation on the user data document set to obtain a user document feature set;
performing data standardization and database archiving on pre-acquired historical approval data to obtain an approval case library;
performing multi-dimensional similarity matching on the user document feature set according to the approval case library to obtain a matched decision result set;
performing autoregressive approval analysis on the user document feature set according to the approval case library to obtain an analyzed decision result set; and
generating a risk control decision result set according to the matched decision result set and the analyzed decision result set.

2. The artificial intelligence-based case-style risk control method according to claim 1,
wherein the step of performing multi-dimensional similarity matching on the user document feature set according to the approval case library to obtain a matched decision result set comprises:
selecting user document features from the user document feature set one by one as target user document features, and selecting historical document features from the historical document feature set in the approval case library one by one as target historical document features;
performing multi-dimensional similarity calculation on the target user document features and the target historical document features to obtain multi-dimensional matching degrees;
aggregating the multi-dimensional matching degrees of all the target historical document features in the approval case library into a multi-dimensional matching degree set;
performing extremum filtering on the multi-dimensional matching degree set to obtain extremum matching degrees, and taking the target historical document features corresponding to the extremum matching degrees as matched historical document features;
taking user approval results corresponding to the matched historical document features in the approval case library as matched decision results; and
aggregating the matched decision results corresponding to all the target user document features in the user document feature set into a matched decision result set.

3. The artificial intelligence-based case-style risk control method according to claim 2, wherein the step of performing multi-dimensional similarity calculation on the target user document features and the target historical document features to obtain multi-dimensional matching degrees comprises:
performing feature hierarchy segmentation on the target user document features to obtain user core features, user behavior features and user derived features;
calculating a matched weight group according to the user core features, the user behavior features and the user derived features;
performing feature hierarchy segmentation on the target historical document features to obtain historical core features, historical behavior features and historical derived features;
calculating core feature matching degrees according to the user core features and the historical core features;
calculating behavior feature matching degrees according to the user behavior features and the historical behavior features;
calculating derivative feature matching degrees according to the user derived features and the historical derived features; and
performing weighted summation on the core feature matching degrees, the behavior feature matching degrees and the derivative feature matching degrees according to the matched weight group to obtain multi-dimensional matching degrees.

4. The artificial intelligence-based case-style risk control method according to claim 1, wherein the step of performing data stratification and document conversion on pre-acquired user information set to obtain a user data document set comprises:
performing data cleaning on the pre-acquired user information set to obtain a cleaning information set;
selecting cleaning information from the cleaning information set one by one as target cleaning information, and performing core data matching on the target cleaning information to obtain target core data;
performing behavior feature extraction on the target cleaning information to obtain target behavior features;
performing risk indicator extraction on the target cleaning information to obtain target derivative data;
performing document conversion on the target core data, the target behavior features and the target derivative data to obtain a user data document; and
generating the user data document set from the user data documents for all target cleaning information in the cleaning information set.

5. The artificial intelligence-based case-style risk control method according to claim 1, wherein the step of performing a temporal embedding operation on the user data document set to obtain a user document feature set comprises:
selecting the user data documents from the user data document set as the target data documents one by one, and performing temporal segmentation on the target data documents to obtain a temporal document sequence;
performing document segmentation on the temporal document sequence to obtain a temporal document phrase sequence;
performing word vector conversion on the temporal document phrase sequence to obtain a temporal word vector group sequence;
performing location encoding on the temporal word vector group sequence to obtain a temporal word feature group sequence;
performing feature concatenation according to the temporal word feature group sequence to obtain a temporal document feature sequence;
performing temporal feature convolution on the temporal document feature sequence to obtain user document features; and
aggregating the user document features of all the target data documents in the user data document set into the user document feature set.

6. The artificial intelligence-based case-style risk control method according to claim 1, wherein the step of performing data standardization and database archiving on pre-acquired historical approval data to obtain an approval case library comprises:
performing user segmentation on the pre-acquired historical approval data to obtain a user approval dataset;
respectively extracting a historical user dataset and a user approval result set corresponding to the historical user dataset from the user approval dataset;
performing data stratification and document conversion on the historical user dataset to obtain a historical user document set;
performing the temporal embedding operation on the historical user document set to obtain the historical document feature set; and
performing database archiving of the historical document feature set and the user approval result set to obtain the approval case library.

7. The artificial intelligence-based case-style risk control method according to claim 1, wherein the step of performing autoregressive approval analysis on the user document feature set according to the approval case library to obtain an analyzed decision result set comprises:
performing approval analysis on the historical document feature set in the approval case library using a pre-set autoregressive model to obtain the analyzed approval result set;
calculating a result loss value between the user approval result set in the approval case library and the analyzed approval result set;
performing iterative model training on the autoregressive model according to the result loss value to obtain an approval case model; and
performing approval analysis on the user document feature set using the approval case model to obtain an analyzed decision result set.

8. An electronic device, comprising: a memory, a processor, wherein the processor is electrically connected to the memory, the memory stores a computer program executable by the at least one processor, the computer program, when executed by the at least one processor, causes the at least one processor to perform the following steps of:
performing data stratification and document conversion on pre-acquired user information set to obtain a user data document set;
performing a temporal embedding operation on the user data document set to obtain a user document feature set;
performing data standardization and database archiving on pre-acquired historical approval data to obtain an approval case library;
performing multi-dimensional similarity matching on the user document feature set according to the approval case library to obtain a matched decision result set;
performing autoregressive approval analysis on the user document feature set according to the approval case library to obtain an analyzed decision result set; and
generating a risk control decision result set according to the matched decision result set and the analyzed decision result set.

9. The electronic device according to claim 8, wherein the step of performing multi-dimensional similarity matching on the user document feature set according to the approval case library to obtain a matched decision result set comprises:
selecting user document features from the user document feature set one by one as target user document features, and selecting historical document features from the historical document feature set in the approval case library one by one as target historical document features;
performing multi-dimensional similarity calculation on the target user document features and the target historical document features to obtain multi-dimensional matching degrees;
aggregating the multi-dimensional matching degrees of all the target historical document features in the approval case library into a multi-dimensional matching degree set;
performing extremum filtering on the multi-dimensional matching degree set to obtain extremum matching degrees, and taking the target historical document features corresponding to the extremum matching degrees as matched historical document features;
taking user approval results corresponding to the matched historical document features in the approval case library as matched decision results; and
aggregating the matched decision results corresponding to all the target user document features in the user document feature set into a matched decision result set.

10. The electronic device according to claim 9, wherein the step of performing multi-dimensional similarity calculation on the target user document features and the target historical document features to obtain multi-dimensional matching degrees comprises:
performing feature hierarchy segmentation on the target user document features to obtain user core features, user behavior features and user derived features;
calculating a matched weight group according to the user core features, the user behavior features and the user derived features;
performing feature hierarchy segmentation on the target historical document features to obtain historical core features, historical behavior features and historical derived features;
calculating core feature matching degrees according to the user core features and the historical core features;
calculating behavior feature matching degrees according to the user behavior features and the historical behavior features;
calculating derivative feature matching degrees according to the user derived features and the historical derived features; and
performing weighted summation on the core feature matching degrees, the behavior feature matching degrees and the derivative feature matching degrees according to the matched weight group to obtain multi-dimensional matching degrees.

11. The electronic device according to claim 8, wherein the step of performing data stratification and document conversion on pre-acquired user information set to obtain a user data document set comprises:
performing data cleaning on the pre-acquired user information set to obtain a cleaning information set;
selecting cleaning information from the cleaning information set one by one as target cleaning information, and performing core data matching on the target cleaning information to obtain target core data;
performing behavior feature extraction on the target cleaning information to obtain target behavior features;
performing risk indicator extraction on the target cleaning information to obtain target derivative data;
performing document conversion on the target core data, the target behavior features and the target derivative data to obtain a user data document; and
generating the user data document set from the user data documents for all target cleaning information in the cleaning information set.

12. The electronic device according to claim 8, wherein the step of performing a temporal embedding operation on the user data document set to obtain a user document feature set comprises:
selecting the user data documents from the user data document set as the target data documents one by one, and performing temporal segmentation on the target data documents to obtain a temporal document sequence;
performing document segmentation on the temporal document sequence to obtain a temporal document phrase sequence;
performing word vector conversion on the temporal document phrase sequence to obtain a temporal word vector group sequence;
performing location encoding on the temporal word vector group sequence to obtain a temporal word feature group sequence;
performing feature concatenation according to the temporal word feature group sequence to obtain a temporal document feature sequence;
performing temporal feature convolution on the temporal document feature sequence to obtain user document features; and
aggregating the user document features of all the target data documents in the user data document set into the user document feature set.

13. The electronic device according to claim 8, wherein the step of performing data standardization and database archiving on pre-acquired historical approval data to obtain an approval case library comprises:
performing user segmentation on the pre-acquired historical approval data to obtain a user approval dataset;
respectively extracting a historical user dataset and a user approval result set corresponding to the historical user dataset from the user approval dataset;
performing data stratification and document conversion on the historical user dataset to obtain a historical user document set;
performing the temporal embedding operation on the historical user document set to obtain the historical document feature set; and
performing database archiving of the historical document feature set and the user approval result set to obtain the approval case library.

14. The electronic device according to claim 8, wherein the step of performing autoregressive approval analysis on the user document feature set according to the approval case library to obtain an analyzed decision result set comprises:
performing approval analysis on the historical document feature set in the approval case library using a pre-set autoregressive model to obtain the analyzed approval result set;
calculating a result loss value between the user approval result set in the approval case library and the analyzed approval result set;
performing iterative model training on the autoregressive model according to the result loss value to obtain an approval case model; and
performing approval analysis on the user document feature set using the approval case model to obtain an analyzed decision result set.

15. A non-volatile computer-readable storage medium having stored thereon a computer program, wherein the computer program, when executed by one or more processors, causes the one or more processors to perform the following steps of:
performing data stratification and document conversion on pre-acquired user information set to obtain a user data document set;
performing a temporal embedding operation on the user data document set to obtain a user document feature set;
performing data standardization and database archiving on pre-acquired historical approval data to obtain an approval case library;
performing multi-dimensional similarity matching on the user document feature set according to the approval case library to obtain a matched decision result set;
performing autoregressive approval analysis on the user document feature set according to the approval case library to obtain an analyzed decision result set; and
generating a risk control decision result set according to the matched decision result set and the analyzed decision result set.

16. The non-volatile computer-readable storage medium according to claim 15, wherein the step of performing multi-dimensional similarity matching on the user document feature set according to the approval case library to obtain a matched decision result set comprises:
selecting user document features from the user document feature set one by one as target user document features, and selecting historical document features from the historical document feature set in the approval case library one by one as target historical document features;
performing multi-dimensional similarity calculation on the target user document features and the target historical document features to obtain multi-dimensional matching degrees;
aggregating the multi-dimensional matching degrees of all the target historical document features in the approval case library into a multi-dimensional matching degree set;
performing extremum filtering on the multi-dimensional matching degree set to obtain extremum matching degrees, and taking the target historical document features corresponding to the extremum matching degrees as matched historical document features;
taking user approval results corresponding to the matched historical document features in the approval case library as matched decision results; and
aggregating the matched decision results corresponding to all the target user document features in the user document feature set into a matched decision result set.

17. The non-volatile computer-readable storage medium according to claim 16, wherein the step of performing multi-dimensional similarity calculation on the target user document features and the target historical document features to obtain multi-dimensional matching degrees comprises:
performing feature hierarchy segmentation on the target user document features to obtain user core features, user behavior features and user derived features;
calculating a matched weight group according to the user core features, the user behavior features and the user derived features;
performing feature hierarchy segmentation on the target historical document features to obtain historical core features, historical behavior features and historical derived features;
calculating core feature matching degrees according to the user core features and the historical core features;
calculating behavior feature matching degrees according to the user behavior features and the historical behavior features;
calculating derivative feature matching degrees according to the user derived features and the historical derived features; and
performing weighted summation on the core feature matching degrees, the behavior feature matching degrees and the derivative feature matching degrees according to the matched weight group to obtain multi-dimensional matching degrees.

18. The non-volatile computer-readable storage medium according to claim 15, wherein the step of performing data stratification and document conversion on pre-acquired user information set to obtain a user data document set comprises:
performing data cleaning on the pre-acquired user information set to obtain a cleaning information set;
selecting cleaning information from the cleaning information set one by one as target cleaning information, and performing core data matching on the target cleaning information to obtain target core data;
performing behavior feature extraction on the target cleaning information to obtain target behavior features;
performing risk indicator extraction on the target cleaning information to obtain target derivative data;
performing document conversion on the target core data, the target behavior features and the target derivative data to obtain a user data document; and
generating the user data document set from the user data documents for all target cleaning information in the cleaning information set.

19. The non-volatile computer-readable storage medium according to claim 15, wherein the step of performing a temporal embedding operation on the user data document set to obtain a user document feature set comprises:
selecting the user data documents from the user data document set as the target data documents one by one, and performing temporal segmentation on the target data documents to obtain a temporal document sequence;
performing document segmentation on the temporal document sequence to obtain a temporal document phrase sequence;
performing word vector conversion on the temporal document phrase sequence to obtain a temporal word vector group sequence;
performing location encoding on the temporal word vector group sequence to obtain a temporal word feature group sequence;
performing feature concatenation according to the temporal word feature group sequence to obtain a temporal document feature sequence;
performing temporal feature convolution on the temporal document feature sequence to obtain user document features; and
aggregating the user document features of all the target data documents in the user data document set into the user document feature set.

20. The non-volatile computer-readable storage medium according to claim 15, wherein the step of performing autoregressive approval analysis on the user document feature set according to the approval case library to obtain an analyzed decision result set comprises:
performing approval analysis on the historical document feature set in the approval case library using a pre-set autoregressive model to obtain the analyzed approval result set;
calculating a result loss value between the user approval result set in the approval case library and the analyzed approval result set;
performing iterative model training on the autoregressive model according to the result loss value to obtain an approval case model; and
performing approval analysis on the user document feature set using the approval case model to obtain an analyzed decision result set.
